(19) United States
(12) Patent Application Publication
(10) Pub. No.: US 2021/0055789 A1
(43) Pub. Date: Feb. 25, 2021

(54) System to Share Input Devices Across Multiple Information Handling Systems and Method Therefor

(71) Applicant: DELL PRODUCTS, LP, Round Rock, TX (US)

(72) Inventors: Anna Yin Tsai, Taipei (TW); Isaac Hsu, Taipei (TW)

(21) Appl. No.: 16/548,655

(22) Filed: Aug. 22, 2019

(51) Int. Cl. G06F 3/01; H04L 29/08; H04L 29/06

(52) U.S. Cl. CPC G06F 3/013; G06F 3/017; H04L 65/40; H04L 67/10; H04L 67/22

(57) ABSTRACT

A method includes receiving information from an input device coupled to an information handling system. An eye-tracking device at the information handling system determines that a gaze point of a user has transitioned from a display device coupled to the information handling to a second display device coupled to a second information handling system. In response to the determining, the information is forwarded to the second information handling system.

### FIELD OF THE DISCLOSURE

This disclosure generally relates to information handling systems, and more particularly relates to sharing input devices across multiple information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems. The software resources include device drivers and firmware that control operation and interoperability of system components.

### SUMMARY

A method may include receiving information from an input device coupled to an information handling system. An eye-tracking device at the information handling system may determine that a gaze point of a user has transitioned from a display device coupled to the information handling to a second display device coupled to a second information handling system. In response to the determining, the information is forwarded to the second information handling system.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the present disclosure;

FIG. 2 is a block diagram illustrating two information handling systems sharing a single set of input devices according to a specific embodiment of the present disclosure;

FIG. 3 is a block diagram illustrating an eye-tracking device monitoring a user's gaze, according to a specific embodiment of the present disclosure;

FIG. 4 is a flow diagram illustrating a method for redirecting information from input devices to another information handling system based on a user's gaze, according to a specific embodiment of the present disclosure;

FIG. 5 is a block diagram illustrating a graphical user interface to define a relative placement and identity of two or more display devices, according to a specific embodiment of the present disclosure; and

FIG. 6 is a flow diagram illustrating a method for defining a placement map according to a specific embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

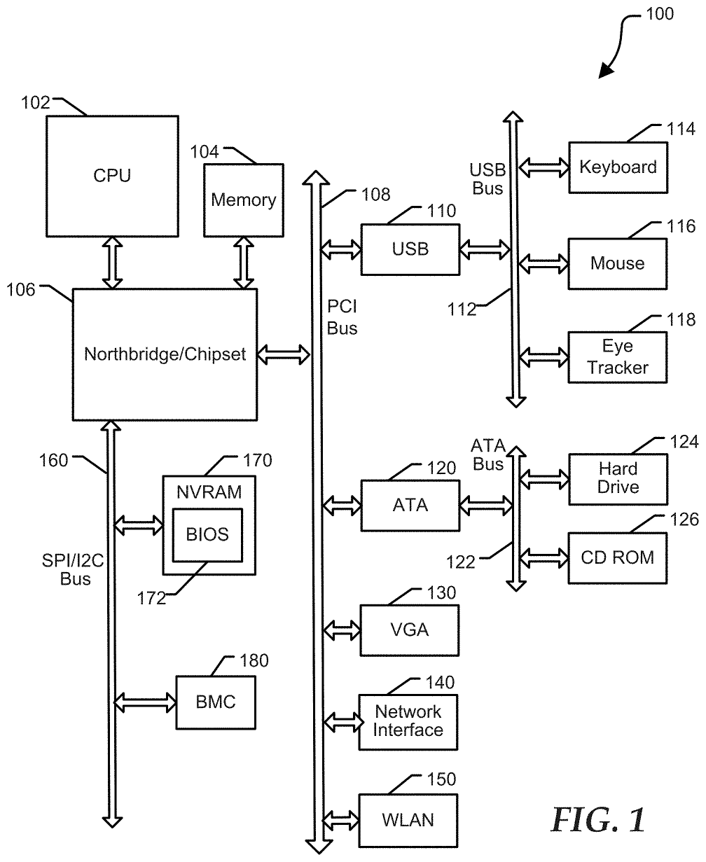

FIG. 1 illustrates an information handling system 100 including a processor 102, a memory 104, a northbridge/chipset 106, a PCI bus 108, a universal serial bus (USB) controller 110, a USB 112, a keyboard device controller 114, a mouse device controller 116, an eye-tracking device 118, an ATA bus controller 120, an ATA bus 122, a hard drive device controller 124, a compact disk read only memory (CD ROM) device controller 126, a video graphics array (VGA) device controller 130, a network interface controller (NIC) 140, a wireless local area network (WLAN) controller 150, a serial peripheral interface (SPI) bus 160, a NVRAM 170 for storing BIOS 172, and a baseboard management controller (BMC) 180. BMC 180 can be referred to as a service processor, an embedded controller (EC), and the like. BMC 180 includes a processor that can operate out-of-band with respect to CPU 102. For example, remote management systems can utilize BMC 180 to access components at information handling system independent of an operating state of CPU 102. BMC 180 may be responsible for performing low level hardware tasks including thermal management and power management operations. NVRAM 170 can be referred to as a SPI flash storage device, BIOS SPI, and the like.

Information handling system 100 can include additional components and additional buses, not shown for clarity. For example, system 100 can include multiple processor cores, audio devices, and the like. While a particular arrangement of bus technologies and interconnections is illustrated for the purpose of example, one of skill will appreciate that the techniques disclosed herein are applicable to other system architectures. System 100 can include multiple CPUs and redundant bus controllers. One ore more components can be integrated together. For example, portions of northbridge/chipset 106 can be integrated within CPU 102. Additional components of information handling system 100 can include one or more storage devices that can store machine-executable code, one or more communications ports for communicating with external devices, and various input and output (I/O) devices, such as a keyboard, a mouse, and a video display.

For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as CPU 102, a programmable logic array (PLA), an embedded device such as a System-on-a-Chip (SoC), or other control logic hardware. Information handling system 100 can also include one or more computer-readable medium for storing machine-executable code, such as software or data.

BIOS 172 can be referred to as a firmware image, and the term BIOS is herein used interchangeably with the term firmware image, or simply firmware. BIOS 172 includes instructions executable by CPU 102 to initialize and test the hardware components of system 100, and to load a boot loader or an operating system (OS) from a mass storage device. BIOS 172 additionally provides an abstraction layer for the hardware, i.e. a consistent way for application programs and OS to interact with the keyboard, display, and other input/output devices. When power is first applied to information handling system 100, the system begins a sequence of initialization procedures. During the initialization sequence, also referred to as a boot sequence, components of system 100 are configured and enabled for operation, and device drivers can be installed. Device drivers provide an interface through which other components of the system 100 can communicate with a corresponding device. In an embodiment, BIOS 172 can provide one or more runtime processes or device drivers that are configured to support functionality disclosed herein.

In an embodiment, the BIOS 172 can be substantially compliant with one or more revisions of the UEFI specification. The UEFI standard replaces the antiquated personal computer BIOS system found in some older information handling systems. However, the term BIOS is often still used to refer to the system firmware. The UEFI specification provides standard interfaces and interoperability guidelines for devices that together make up an information handling system. In particular, the UEFI specification provides a standardized architecture and data structures to manage initialization and configuration of devices, booting of platform resources, and passing of control to the OS. The UEFI specification allows for the extension of platform firmware by loading UEFI driver and UEFI application images. For example, an original equipment manufacturer can include customized or proprietary images to provide enhanced control and management of the information handling system 100. While the techniques disclosed herein are described in the context of a UEFI compliant system, one of skill will appreciate that aspects of the disclosed systems and methods can be implemented at substantially any information handling system having configurable firmware.

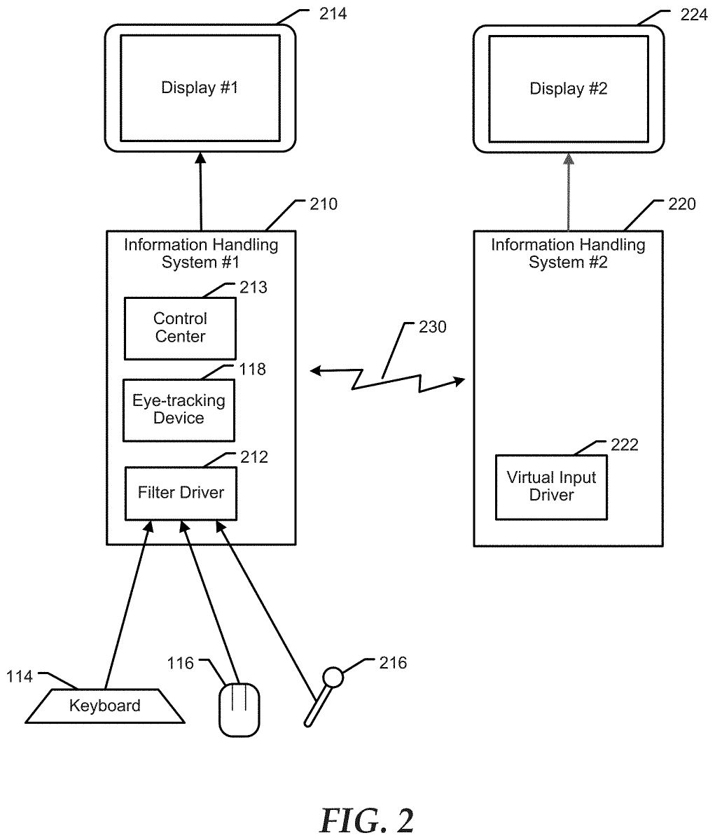

It is not uncommon for an individual to utilize two or more information handling systems at a work environment. Typically, each information handling system includes a corresponding set of input devices, such as a keyboard and mouse, and each system operates autonomously. In such an environment, a user may accidently use an input device (keyboard, mouse, voice assistant) associated with the wrong system. Such an error could be serious, for example if a user were to accidently type a password on the wrong keyboard. As disclosed herein, a single set of input devices are shared between two or more information handling systems. In particular, eye-tracking technology is used to automatically couple the input devices to an intended information handling system. These techniques can be better understood with reference to FIGS. 2-6.

FIG. 2 shows two information handling systems sharing a single set of input devices according to a specific embodiment of the present disclosure. FIG. 2 includes an information handling system 210 and a corresponding display device 214, and another information handling system 220 and a corresponding display device 224. Information handling system 210 includes eye-tracking device 118, and a filter driver 212. Information handling system 210 is coupled to three input devices, including a keyboard 114, a mouse 116, and a microphone 216. Information handling system 220 includes a virtual input driver 222. In an embodiment, system 220 does not have dedicated input devices. Information handling system 210 is coupled to information handling system 220 via a wireless communication interface 230, such as a Wi-Fi, Bluetooth, and the like.

During operation, eye-tracking device 118 is configured to determine a gaze point of a user to identify whether the user is directing their attention at display device 214 or at display device 224. Alternatively, eye-tracking device 118 may be configured to determine that a gaze direction of the user is moving away from display device 214, such as to the left or to the right of display device 214. In an embodiment, a graphical user interface (GUI) can be provided to enable a user to specify the identity of each information handling system and to specify the relative position of a display device associated with each system. For example, a placement map generated using the GUI can specify that display device 224 is to the right of display device 214. A runtime process, control center 213 executing at information handling system 210 can utilize the placement information to interpret eye-tracking information provided by device 118.

Filter driver 212 is configured to selectively forward information received from input devices 114, 116, and 216 to an appropriate information handling system based on information provided by eye-tracking device 118. For example, if eye-tracking device determines that a user's gaze is directed at display device 214, filter driver 212 can pass keyboard, mouse, and microphone information directly to information handling system 210. In the event that eye-tracking device 118 determines that the user's gaze has shifted towards display device 224, based on the placement map, filter driver 212 can discontinue passing the information received from the input devices to system 210, and instead forward the information to virtual input driver 222 via wireless communication interface 230. The forwarded keyboard, mouse, and microphone information can be provided to processes running at information handling system 220. In another embodiment, a wired communication interface such as a local-area Ethernet network (not shown at FIG. 2) can be used to forward information received from input devices 114, 116, and 216 to information handling system 220. Similarly, once eye-tracking device 118 determines that the user's gaze has returned to display device 214, control center 213, and filter driver 212 can stop forwarding the input information to system 220 and return to passing the information to system 210. One of skill will appreciate that input devices 114, 116, and 216 are merely examples, and that information from other devices, such as touch pads, fingerprint readers, and the like, can be forwarded to another system based on eye-tracking information.

In an embodiment, information handling system 220 may include an eye-tracking device (not shown at FIG. 2). Another runtime process executing at system 220 can verify that the user's gaze is indeed directed towards display device 224, or that the user's gaze has moved to the left, away from display device 224. The runtime processes at each information handling system can exchange information over wireless communication link 230 to further control the forwarding operation of filter driver 212.

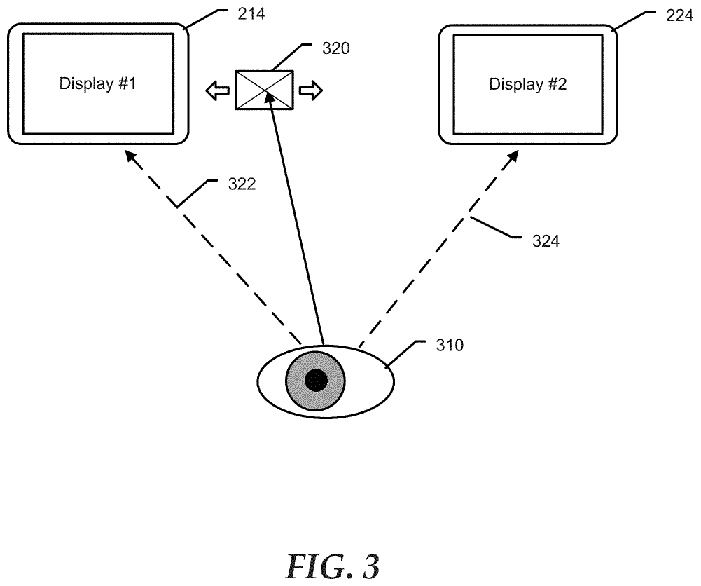

FIG. 3 shows how eye-tracking device 118 can monitor a user's gaze, according to a specific embodiment of the present disclosure. FIG. 3 includes a representation of a user's eye 310 as the user's gaze pans between display devices 214 and 224. In particular, eye-tracking device 118 can determine whether the user is looking directly at display device 214, indicated by gaze vector 322, and can determine that the user's gaze has moved to the right, away from display device 214, indicated by gaze vector 320. As described above, precise gaze angle is not required to control filter driver 212. Instead, control center 213 at information handling system 210 needs only to determine that the user's gaze has moved away from display device 214 in a direction corresponding to a device identified in the placement map. Eye-tracking device 118 can incorporate any suitable technology to identify the change in a user's gaze direction. In one embodiment, a software application can process video data provided by camera that is directed at the user's face. In another embodiment, eye-tracking device 118 includes a light source, typically infrared, that illuminates a user's eye, while a video camera or proprietary optical sensor interprets changes in reflection of the light source from the eye.

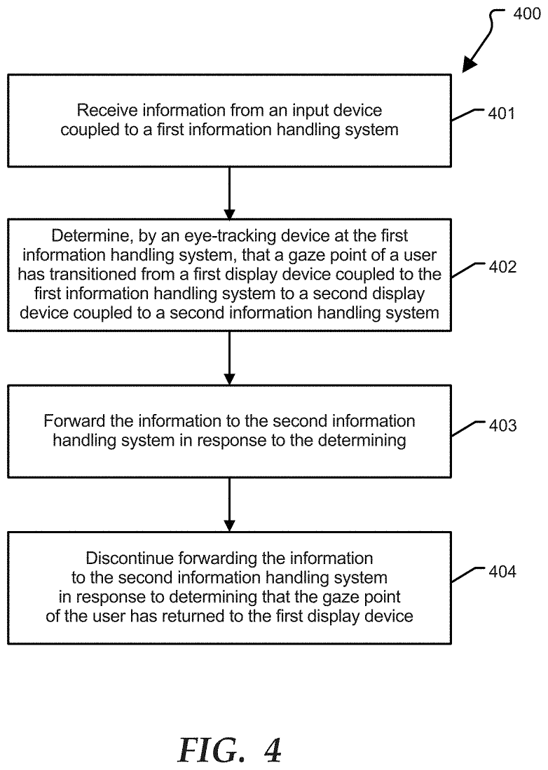

FIG. 4 shows a method 400 for redirecting information from input devices to another information handling system based on a user's gaze, according to a specific embodiment of the present disclosure. Method 400 begins at block 401 where information is received from an input device coupled to a first information handling system. For example, information handling system 210 can receive information entered by a user at keyboard 114, mouse 116, and the like. The information can be passed to applications executing at information handling system 210 by filter driver 212. At block 402, an eye-tracking device at the first information handling system can determine that a gaze point of a user has transitioned from a first display device coupled to the first information handling to a second display device coupled to a second information handling system. For example, control center 213 executing at information handling system 210 can utilize a placement map that describes the location of one or more alternative display device relative to the location of display device 214, such as display device 224 located to the right of display device 218.

At block 403, the information received from the input devices can be forwarded to the second information handling system in response to the determining that the user's gaze is now directed to the second display device. For example, filter driver 212 can discontinue passing information from keyboard 114 to information handling system 210 and instead forward the keyboard information received at filter driver 212 to information handling system 220 via communication network 230. At block 404, forwarding of the information to the second information handling system can be discontinued in response to determining that the gaze point of the user has returned to the first display device.

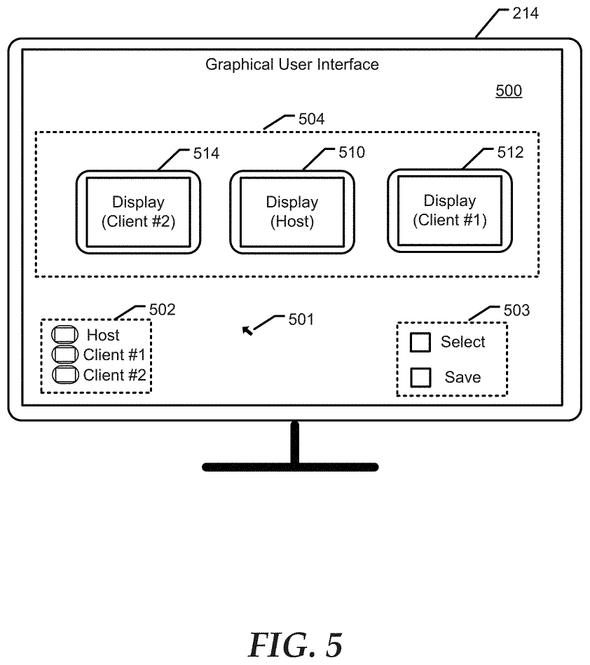

FIG. 5 shows a graphical user interface 500 that can be used to define the relative placement and identity of two or more display devices, according to a specific embodiment of the present disclosure. In an embodiment, graphical user interface (GUI) 500 can be provided at the information handling system having attached input devices, such as keyboard 114, referred to herein as the host system. GUI 500 can include a pallet of widgets 502 representing information handling systems that are available for mapping, such as host 510, client #1 512, and client #2 514. For example, pallet 502 may include two or more information handling systems that share a local area network with host system 510. GUI 500 may include a cursor 501 and one or more graphical buttons 503 that enable a user to place desired widgets at map 504 to define the relative location of display devices associated with each system.

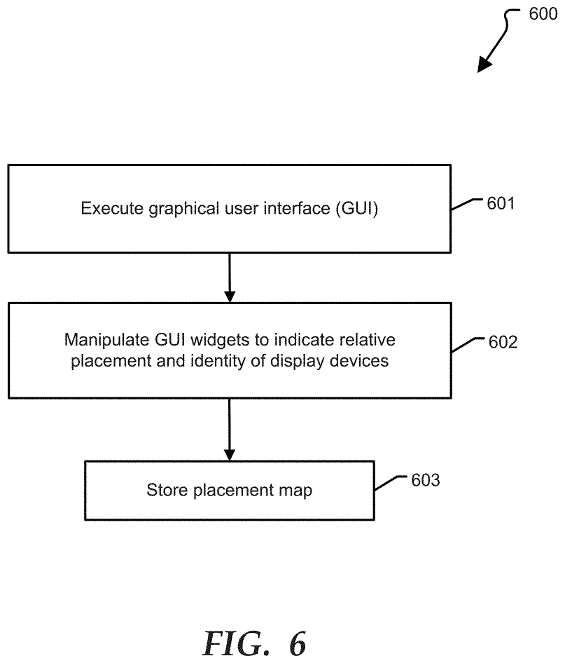

As illustrated at FIG. 5, a user has manipulated GUI 500 to indicate that display device 512 associated with client #1 is located to the right of display device 510 associated with host system, and that display device 514 associated with client #2 is located to the left of display device 510. In an embodiment, the pallet can identify each of the available information handling systems by name or by another suitable identifier. For example, host 510 and client 512 may be personal computers, while client 514 can be a mobile device, such as a telephone. Having completed specifying the placement map 504, the user can save the map by clicking a save button at buttons 503. FIG. 6 shows a method 600 for defining a placement map according to a specific embodiment of the present disclosure. At block 601, a user invokes an application providing a graphical user interface that is configured to generate a placement map. At block 602, the user can manipulate widgets at the GUI to indicate relative placement and identity of display devices. Method 600 completes at block 603 where the placement map generated at the GUI is saved for use by eye-tracking device 118 and associated control center 213.

In an embodiment, other information can be forwarded from one information handling system to another based on affinity information received from eye-tracking device 118. For example, a user can perform a copy/paste operation between word processing applications running at information handling system 210 and 220 by selecting a string from an application at system 210, redirecting their gaze to display 224, and pasting the string to the word processing application executing at system 220. In a similar manner, a user may copy files or directories between systems. In another embodiment, input devices such as keyboard 114, mouse 116, and microphone 216 may be connected to a switch device external to information handling systems 210 and 220. The switch device can include outputs to selectively forward information received from the input devices to a selected information handling system, and an input to receive commands from eye-tracking device 118 at system 210. During operation, eye-tracking device 118 and associated runtime processes can determine a gaze direction of a user and command the external switch device to forward the information received from the input devices to the appropriate system based on the users gaze.

Referring back to FIG. 1, the information handling system 100 can include a set of instructions that can be executed to cause the information handling system to perform any one or more of the methods or computer based functions disclosed herein. The information handling system 100 may operate as a standalone device or may be connected to other computer systems or peripheral devices, such as by a network.

In a networked deployment, the information handling system 100 may operate in the capacity of a server or as a client user computer in a server-client user network environment, or as a peer computer system in a peer-to-peer (or distributed) network environment. The information handling system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single information handling system 100 is illustrated, the term “system” shall also be taken to include any collection of systems or sub-systems that individually or jointly execute a set, or multiple sets, of instructions to perform one or more computer functions.

The information handling system 100 can include a disk drive unit and may include a computer-readable medium, not shown in FIG. 1, in which one or more sets of instructions, such as software, can be embedded. Further, the instructions may embody one or more of the methods or logic as described herein. In a particular embodiment, the instructions may reside completely, or at least partially, within system memory 104 or another memory included at system 100, and/or within the processor 102 during execution by the information handling system 100. The system memory 104 and the processor 102 also may include computer-readable media. A network interface device (not shown at FIG. 1) can provide connectivity to a network, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal; so that a device connected to a network can communicate voice, video or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories.

Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. An information handling system comprising:
a first display device;
an eye-tracking device to determine a gaze point of a user of the information handling system;
a keyboard to receive first information generated by the user; and
a processor configured to forward the first information to a second information handling system in response to determining that the gaze point of the user has transitioned from the first display device to a second display device coupled to the second information handling system.

2. The information handling system of claim 1, wherein the processor is further to discontinue forwarding the first information to the second information handling system in response to determining that the gaze point of the user has returned to the first display device.

3. The information handling system of claim 1, wherein the processor is further configured to forward the first information to a third information handling system in response to determining that the gaze point of the user has transitioned from the first display device to a third display device coupled to the third information handling system.

4. The information handling system of claim 1, wherein the second information handling system is a mobile phone device.

5. The information handling system of claim 1, wherein the second information handling system includes a second eye-tracking device to determine whether the gaze point of the user is directed to the second display device.

6. The information handling system of claim 1, wherein the keyboard is connected to a Universal Serial Bus interface included at the information handling system.

7. The information handling system of claim 1, further comprising a mouse device to receive cursor control information from the user, and wherein the processor is further configured to forward the cursor control information to the second information handling system in response to determining that the gaze point of the user has transitioned from the first display device to the second display device.

8. The information handling system of claim 1, further comprising a microphone device to receive voice information from the user, and wherein the processor is further configured to forward the voice information to the second information handling system in response to determining that the gaze point of the user has transitioned from the first display device to the second display device.

9. The information handling system of claim 1, wherein the processor is further configured to provide a graphical user interface to enable the user to identify a location of the second display device relative to the first display device.

10. The information handling system of claim 1, wherein the information is forwarded to the second information handling system via a wireless communication network.

11. A method comprising:
receiving first information generated by a user of a keyboard, the keyboard coupled to a first information handling system;
determining, by an eye-tracking device at the first information handling system, that a gaze point of a user has transitioned from a first display device coupled to the first information handling to a second display device coupled to a second information handling system; and
forwarding the first information to the second information handling system in response to the determining.

12. The method of claim 11, further comprising:
discontinuing the forwarding of the first information to the second information handling system in response to determining that the gaze point of the user has returned to the first display device.

13. The method of claim 11, further comprising:
forwarding the first information to a third information handling system in response to determining that the gaze point of the user has transitioned from the first display device to a third display device coupled to the third information handling system.

14. The method of claim 11, wherein the second information handling system includes a second eye-tracking device to determine whether the gaze point of the user is directed to the second display device.

15. The method of claim 11, wherein the keyboard is connected to a Universal Serial Bus interface included at the information handling system.

16. The method of claim 11, further comprising receiving cursor control information from a mouse device coupled to the information handling system, the method further comprising forwarding the cursor control information to the second information handling system in response to determining that the gaze point of the user has transitioned from the first display device to the second display device.

17. The method of claim 11, further comprising:
providing a graphical user interface to enable the user to identify a location of the second display device relative to the first display device.

18. A system comprising:
a first information handling system including a mouse device to receive cursor control information generated by a user;
a second information handling system without an attached mouse device;
an eye-tracking device at the first information handling system to determine a gaze point of the user; and
a processor at the first information handling system to forward the cursor control information to the second information handling system in response to determining that the gaze point of the user has transitioned from a first display device coupled to the first information handling system to a second display device coupled to the second information handling system.

19. The system of claim 18, wherein the processor is further configured to:
discontinue forwarding the first information to the second information handling system in response to determining that the gaze point of the user has returned to the first display device.

20. The system of claim 18, wherein the second information handling system includes a second eye-tracking device to determine whether the gaze point of the user is directed to the second display device.
